(19) United States
(12) Patent Application Publication
(10) Pub. No.: US 2007/0057764 A1
(43) Pub. Date: Mar. 15, 2007

(54) Mobile communication terminal, authentication method and authentication program

(75) Inventors: Tetsushi Sato, Tokyo (JP); Masamichi Shimoda, Tokyo (JP); Hideki Asada, Tokyo (JP); Tatsuya Uchikawa, Tokyo (JP); Daisuke Suzuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/516,596

(22) Filed: Sep. 7, 2006

(30) Foreign Application Priority Data
Sep. 14, 2005 (JP) 2005-267558

(51) Int. Cl. G05B 19/00; G06K 9/00

(52) U.S. Cl. 340/5.52; 382/115

(57) ABSTRACT

A mobile communication terminal having a security function using biological information for authentication includes: authentication units for performing authentication based on at least two kinds of biological information; and a control unit for performing operational control of the authentication units. The control unit has a function of proceeding with capturing of biological information and authentication processing based on the captured biological information, performed for the respective kinds of biological information by the authentication units, in parallel.

### BACKGROUND OF THE INVENTION

1. Field of the Invention

The present invention relates to mobile communication terminals such as mobile phones, authentication methods and authentication programs in which authentication is performed by using biological features.

2. Related Art

As a mobile communication terminal has been advanced to include multiple functions in recent years, it is not only capable of storing large amount of personal information such as telephone numbers and e-mail addresses but also used for goods transactions and financial operations by accessing the Internet. Therefore, a high security function is required even in a mobile communication terminal.

In an authentication method by means of entering a password, which has been widely used conventionally, there has been a problem of easy spoofing if a password is leaked by a stealthy glance or the like.

To cope with it, authentication methods using biological information such as fingerprint, iris and vein draw attention.

Iris authentication is generally a system in which patterns of wrinkles extending outward from the pupil are captured with a near infrared ray, and collation is performed by using the image data. Japanese Patent Application Laid-open No. 2002-330318 (FIG. 2, Page 3) (Patent Document 2) discloses a mobile communication terminal having an iris authentication device. Vain authentication is a system in which vein patterns are extracted by irradiating an infrared ray, and collation is performed by using the image data, which is considered as hard to counterfeit.

In authentications using such biological information, the probability of authentication cannot be 100%, and there still remains a possibility of authenticating a different person having similar biological information as a person in question.

In order to improve the accuracy of authentication, a method of combining multiple kinds of biometrics has been devised. Japanese Patent Application Laid-open No. 11-146057 (FIG. 4, Page 5) (Patent Document 1) discloses a mobile phone including multiple kinds of biometrics.

However, in the mobile phone including multiple biometrics described in Patent Document 1, accuracy of authentication is improved but the multiple biometrics must be processed sequentially. A mobile phone is convenient because of its immediacy, so sequential processing of multiple biometrics as mentioned above will impair the convenience of the mobile phone, and cause a problem of authenticating operation being bothersome.

Further, a mobile communication terminal having an iris authentication device described in Patent 2 includes an infrared transmission filter, so a photographing function with visible light of a solid photographing element of the terminal is limited to capturing images for iris authentication by the infrared transmission filter. Therefore, in order to enable both photographing for iris authentication and photographing with visible light, another camera function capable of photographing with visible light must be added. Corresponding to it, another camera must be added, causing a problem that size enlargement and cost increase cannot be avoided.

Further, mounting a plurality of biometrics devices in a mobile communication terminal causes a problem of size enlargement and cost increase.

### SUMMARY OF THE INVENTION

It is therefore an object of the present invention to provide mobile communication terminals, authentication methods and authentication programs capable of easily performing authentication by means of multiple biological features.

In order to achieve such an object, a mobile communication terminal according to the present invention is a terminal having a security function using biological information for authentication, comprising: authentication units for performing authentication based on at least two kinds of biological information; and a control unit for controlling operation of the authentication units. The control unit has a function of proceeding with capturing of the biological information and authentication processing based on the captured biological information, performed for the respective kinds of biological information by the authentication units, in parallel.

The authentication unit captures biological information by each kind of biological information and performs authentication based on the captured biological information. Based on the authentication result, the authenticity, that is, whether he/she is the person in question or he/she spoofs, is determined. In the present invention, capturing of biological information and authentication processing based on the captured biological information, performed for the respective kinds of biological information by the authentication units, are proceeded in parallel.

The authentication units may include at least an iris authentication unit for performing authentication based on biological information of iris, and a camera of the iris authentication unit may also be used as a camera for capturing image data with visible light to be provided in the mobile communication terminal.

According to this configuration, there is no need to provide a camera for capturing image data with visible light in addition to a camera for capturing iris authentication data. Therefore, it is possible to incorporate a camera having two functions in a mobile communication terminal without increasing the size and weight of the mobile communication terminal.

Further, the iris authentication unit may be so configured that the camera has a filter mechanism which transmits visible light and an infrared ray by switching between them. In such a case, an infrared ray irradiation mechanism used for capturing authentication data by the iris authentication unit may also be used for data communications.

According to this configuration, it is possible to provide two functions using different rays for capturing data in one camera mechanism with a simple configuration of filter mechanism.

Further, the authentication units may be so configured as to include at least a vein authentication unit for performing authentication based on biological information of vein, and a camera of the vein authentication unit may also be used as a camera for capturing image data with visible light to be provided in the mobile communication terminal. In such a case, it is desirable to provide a filter mechanism in the camera so as to transmit visible light and an infrared ray by switching between them. Further, an infrared ray irradiation mechanism used for capturing authentication data by the vein authentication unit may also be used for data communications.

Further, the authentication units may be so configured as to include at least an iris authentication unit and a vein authentication unit for performing authentication based on biological information of iris and vein, and a camera of one of the iris authentication unit and the vein authentication unit may also be used as a camera for capturing image data with visible light to be provided in the mobile communication terminal. In such a case, it is desirable to provide a filter mechanism in the camera of the iris authentication unit or the vein authentication unit so as to transmit visible light and an infrared ray by switching between them Further, an infrared ray irradiation mechanism used for capturing authentication data by the iris authentication unit and the vein authentication unit may also be used for data communications.

In this way, it is possible to improve the probability of authentication in a mobile communication terminal by performing authentication with a combination of different kinds of authentication units. Further, by using an infrared ray irradiation mechanism used for capturing authentication data for data communications, one infrared ray irradiation mechanism can be used in two ways.

As described above, the present invention is characterized in that capturing of biological information and authentication processing based on the captured biological information, performed for respective kinds of biological information by the authentication units, are proceeded in parallel. According to this characteristic, instead of a configuration in which a camera for capturing image data with infrared ray irradiation to be provided in the authentication unit is also used as a camera for capturing image data with visible light to be provided in the mobile communication terminal, an infrared ray irradiation mechanism used for capturing authentication data by the authentication unit may also be used for data communications. In other words, in addition to the configuration having a security function using biological information for authentication, that is, a configuration in which capturing of biological information and authentication processing based on the captured biological information performed for respective kinds of biological information by the authentication units are proceeded in parallel, the mobile communication terminal according to the present invention may include at least, as an authentication unit, an iris authentication unit for performing authentication based on biological information of iris, and an infrared ray irradiation mechanism used for capturing authentication data by the iris authentication unit may also be used for data communications.

Further, as the authentication unit, the mobile communication terminal may include at least a vein authentication unit for performing authentication based on biological information of vein, and an infrared ray irradiation mechanism used for capturing authentication data by the vein authentication unit may also be used for data communications. Further, as the authentication units, the mobile communication terminal may include at least an iris authentication unit and a vein authentication unit for performing authentication based on biological information of iris and vein, and an infrared ray irradiation mechanism used for capturing authentication data by one of the iris authentication unit and the vein authentication unit may also be used for data communications.

Further, an authentication method for performing authentication by using a mobile communication terminal according to the present invention comprises the steps of: capturing data of different kinds of biological information of a user handling the mobile communication terminal; and performing authentication based on the biological information captured in the step of capturing data. The authentication method is so configured that capturing of the biological information and authentication processing based on the captured biological information, performed for respective kinds of biological information, are proceeded in parallel.

Further, an authentication program for driving a microprocessor of a mobile communication terminal according to the present invention is configured to prompt the microprocessor incorporated in the mobile communication terminal to execute: a function of authentication units to perform authentication based on at least two kinds of biological information; and a function of a control unit having a function to proceed with capturing of the biological information and authentication processing based on the captured biological information, performed for respective kinds of biological information by the authentication units, in parallel.

(Effects of the Invention)

As described above, according to the present invention, authentication accuracy can be improved by using at least two kinds of biometrics, and since at least two kinds of biological information are inputted simultaneously and authentication processing is performed in parallel, it is possible to reduce bothersome works compared with conventional case in which multiple kinds of biometrics are performed sequentially. Further, since multiple kinds of biometrics are performed in parallel, it is possible to reduce the processing time so as to improve convenience of the mobile communication terminal in its immediacy.

Further, since cameras used for iris authentication and vein authentication can be switched to perform a camera function of capturing images with visible light at the time other than authentication, there is no need to add a camera function capable of photographing with visible light. Switching between camera functions is performed automatically, so it does not bother user's operation. Further, switching between camera functions is performed automatically corresponding to whether photographing is for authentication using biological information or not. Therefore, it is possible to capture visible light image desired by the user securely, which will never cause any adverse effect by performing photographing for authentication using biological information and visible light photographing with the same camera.

Further, by connecting an infrared ray irradiation mechanism used for iris authentication and vein authentication with an infrared ray data communication circuit at any time other than authentication, it is possible to realize a lower priced and smaller mobile communication terminal compared with the case of adding an infrared ray data communication mechanism separately to the conventional mobile communication terminal including the iris or vein authentication unit.

### BRIEF DESCRIPTION OF THE DRAWINGS

FIG. 1 is a front view showing a mobile phone according to an embodiment 1 of the present invention;

FIG. 2 is a sectional view showing a camera used in the embodiment 1 of the present invention;

FIGS. 3A and 3B are diagrams showing a filter mechanism for switching between an infrared transmission filter and an infrared cut filter in the embodiment of the present invention;

FIG. 4 is a block diagram showing the circuit configuration of a mobile phone according to embodiments 1 and 2 of the present invention;

FIG. 5 is a flowchart showing the authentication operation of the embodiment 1 of the present invention;

FIG. 6A is a front view of a mobile phone according to an embodiment 2 of the present invention, and FIG. 6B is a rear view thereof;

FIG. 7 is a flowchart showing the authentication operation of the embodiment 2 of the present invention;

FIG. 8A is a front view of a mobile phone according to an embodiment 3 of the present invention, and FIG. 8B is a rear view thereof;

FIG. 9 is a block diagram showing the circuit configuration of the mobile phone according to the embodiment 3 of the present invention; and

FIG. 10 is a flowchart showing the authentication operation of the embodiment 3 of the present invention.

### DESCRIPTION OF PREFERRED EMBODIMENTS

Hereinafter, embodiments of the present invention will be explained with reference to the drawings.

A mobile communication terminal according to the embodiments of the present invention includes, as a basic configuration: authentication units for performing authentication based on at least two kinds of biological information; and a control unit for controlling operation of the authentication unit, in a mobile communication terminal having a security function using biological information for authentication. The control unit has a function of proceeding with capturing of biological information and authentication processing based on the captured biological information, performed for respective kinds of biological information by the authentication units, in parallel.

An authentication method for performing authentication by using a mobile communication terminal according to the present embodiment is to capture different kinds of biological information of a user handling the mobile communication terminal, and to perform authentication based on the captured biological information. Capturing of biological information and authentication processing based on the captured biological information, performed for respective kinds of biological information, are proceeded in parallel.

(Embodiment 1)

An example of performing authentication (identification) by using images of iris and fingerprint of a user as biological information, by applying an embodiment of the present invention to a mobile phone which is a mobile communication terminal, will be explained as an embodiment 1.

(Description of Configuration)

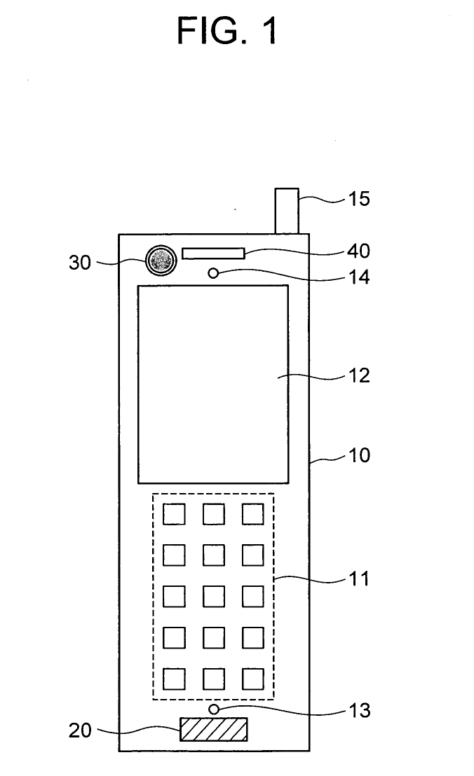

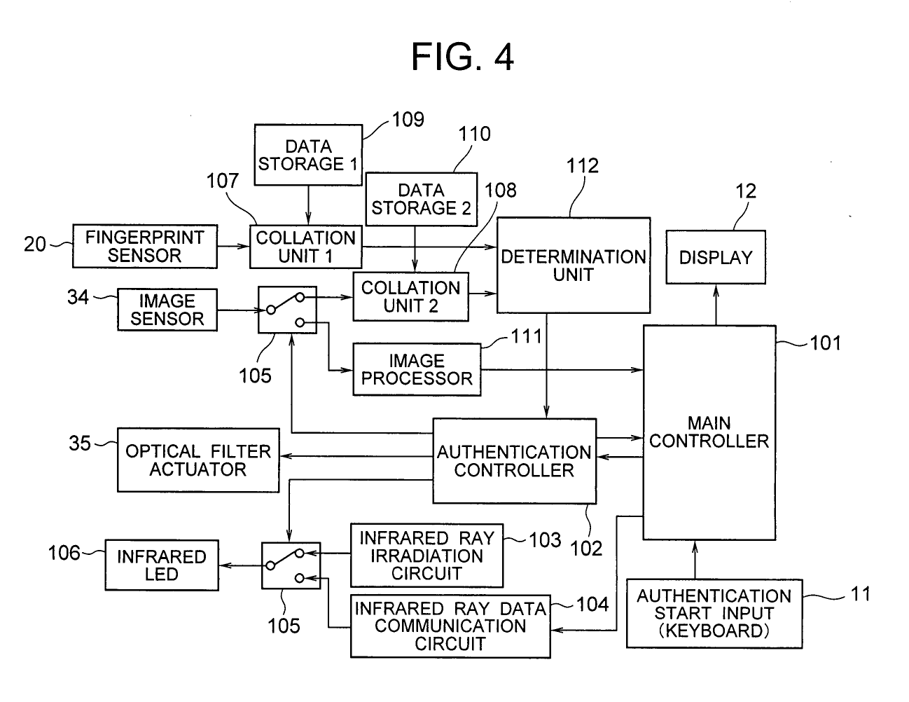

As shown in FIG. 1, a mobile phone 10 includes: a keyboard 11 for inputting various operations; a display 12 for displaying various information such as operational states; a microphone 13 for collecting voices; a speaker 14 for giving sounds; an antenna 15 for transmitting/receiving radio waves; a fingerprint sensor 20 for performing fingerprint authentication; a camera 30 for capturing iris images; and an infrared ray irradiation mechanism 40 for irradiating an infrared ray to iris when an iris image is captured. The fingerprint sensor 20 is provided at a position where a finger of a user shades the fingerprint sensor 20 when the user holds the mobile phone 10. Further, the camera 30 and the infrared ray irradiation mechanism 40 of the mobile phone 10 are arranged so as to capture objects present on the side of the display 12 and the keyboard 11. Further, the infrared ray irradiation mechanism 40 is also used for data communications when it is switched and connected with an infrared ray data communication circuit (see FIG. 4).

Note that the mobile phone 10 shown in FIG. 1 is an example of a mobile communication terminal, and the positions of the keyboard, display, microphone, camera, infrared ray irradiation mechanism and the like and the casing shape of the mobile phone 10 are not limited to those shown in FIG. 1.

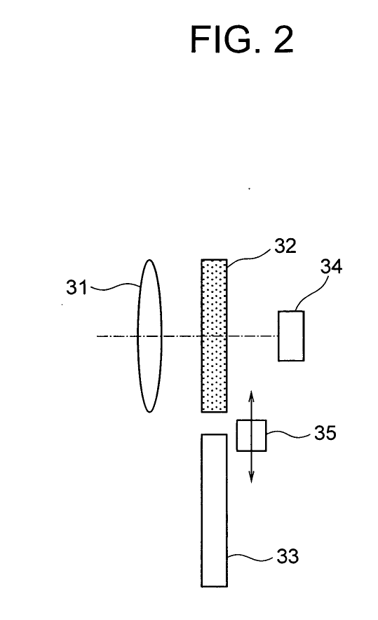

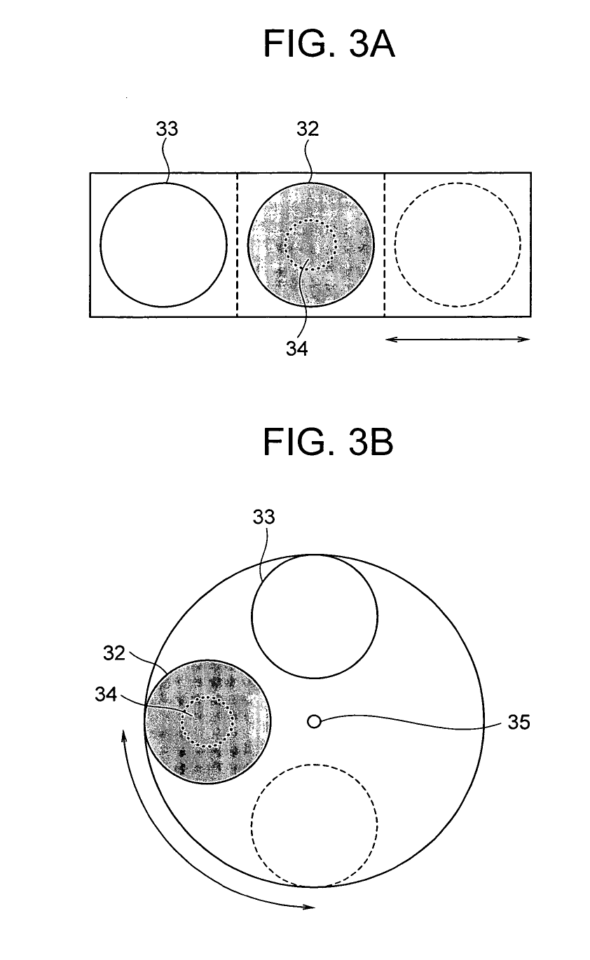

The specific configuration of the camera 30 will be explained by using FIGS. 2 and 3. As shown in FIG. 2, the camera 30 includes: a lens 31 for imaging light from a photographing object on an image sensor 34; an infrared transmission filter 32 which transmits a near infrared ray while cutting visible light; an infrared cut filter 33 which transmits visible light while cutting a near infrared ray; and an optical filter switching actuator 35 for switching between the infrared transmission filter 32 and the infrared cut filter 33 so as to dispose between or remove from the lens 31 and the image sensor 34. The image sensor 34 is an image sensor consisting of a solid-state image sensor such as a CCD (Charge Coupled Device) or a C-MOS image sensor.

When performing authentication, that is, capturing an iris image, the actuator 35 sets the infrared transmission filter 32 between the lens 31 and the image sensor 34, and at any time other than performing authentication (capturing iris image), the actuator 35 sets the infrared cut filter 33 between the lens 31 and the image sensor 34 instead of the infrared transmission filter 32. Here, the infrared transmission filter 32, the infrared cut filter 33 and the small optical filter switching actuator 35 constitute a filter mechanism which switches between visible light and an infrared ray and transmits either of them to the solid-state image sensor 34.

The mechanism for switching the optical filters 32 and 33 by using the actuator 35 may be a sliding mechanism shown in FIG. 3A or a rotating mechanism shown in FIG. 3B. The sliding mechanism shown in FIG. 3A has such a configuration that the infrared transmission filter 32 and the infrared cut filter 33 are mounted to the opening of the filter frame 36 linearly moving in a direction crossing the optical axis between the lens 31 and the image sensor 34, and the infrared transmission filter 32 and the infrared cut filter 33 are switched by sliding the filter frame 36. On the other hand, the rotating mechanism shown in FIG. 3B has such a configuration that the infrared transmission filter 32 and the infrared cut filter 33 are mounted to the opening of a rotary table 37 along the peripheral direction of the rotary table 37 rotating about the axis 35, and the infrared transmission filter 32 and the infrared cut filter 33 are switched by angularly rotating the rotary table 37.

Next, the circuit configuration of the mobile phone 10 as a mobile communication terminal according to the present embodiment will be explained based on FIG. 4. A main controller 101 incorporated in the mobile phone 10 shown in FIG. 4 is connected with the keyboard 11 and the display 12, and based on manipulation of the keyboard 11, the main controller 101 controls functions of the mobile phone such as sending/receiving calls, viewing stored data including address book, and accessing the Internet.

An authentication controller 102 has a function of performing various controls at the time of authentication upon receiving signals from the main controller 101.

As shown in FIG. 4, the infrared ray irradiation mechanism 40 shown in FIG. 1 includes an infrared LED 106, an infrared ray irradiation circuit 103, an infrared ray data communication circuit 104, and a selector 105. With a signal from the authentication controller 102 to the selector 105, the infrared LED 106 is connected with the infrared ray irradiation circuit 103 when performing authentication, and the infrared LED 106 is connected with the infrared ray data communication circuit 104 at any time other than performing authentication, in the infrared ray irradiation mechanism 40.

The infrared ray data communication circuit 104 is connected with the main controller 101, and is so configured as to be capable of performing data communications with other equipment, not shown, with infrared ray upon receiving a signal from the main controller 101 at any time other than performing authentication. Note that if an infrared ray receiving unit is provided inside the infrared ray data communication circuit 104, not only transmission like an infrared ray remote controller but also bidirectional communications are also possible.

The optical filter switching actuator 35 for switching between the infrared transmission filter 32 and the infrared cut filter 33 provided to the camera 30 shown in FIG. 1 and an output selector 105 of the image sensor 34 are controlled based on signals from the authentication controller 102.

More specifically, when the actuator 35 receives a signal to perform authentication from the authentication controller 102, the actuator 35 sets the infrared transmission filter 32 in front of the image sensor 34, and when the output selector 105 receives a signal to perform authentication, the output selector 105 connects the image sensor 34 and the collation unit 108. Therefore, the image sensor 34 captures an image for authentication through the infrared transmission filter 32, and outputs the image data to the collation unit 108. On the other hand, when the actuator 35 receives a signal not for authentication, the actuator 35 sets the infrared cut filter 33 in front of the image sensor 34 instead of the infrared transmission filter 32, and when the output selector 105 receives a signal not for authentication, the output selector 105 connects the image sensor 34 and the image processor 111. Therefore, the image sensor 34 captures an image transmitted through the infrared cut filter 33, and outputs the image data to the image processor 111.

The image processor 111 is connected with the main controller 101, and processes an image such as a person with visible light into electronic data such as JPEG usable and editable by applications, and outputs the electronic data to the main controller 101. The main controller 101 stores the electronic data received from the image processor 111 on a memory, and based on an input of a signal corresponding to manipulation of the keyboard 11, it displays image data of the electronic data on the display 12.

Therefore, one camera 30 shown in FIG. 1 exhibits a camera function of capturing an image for authentication by irradiating an infrared ray and a camera function of capturing an image with visible light by switching the filter 32 and 33.

(Description of Operation)

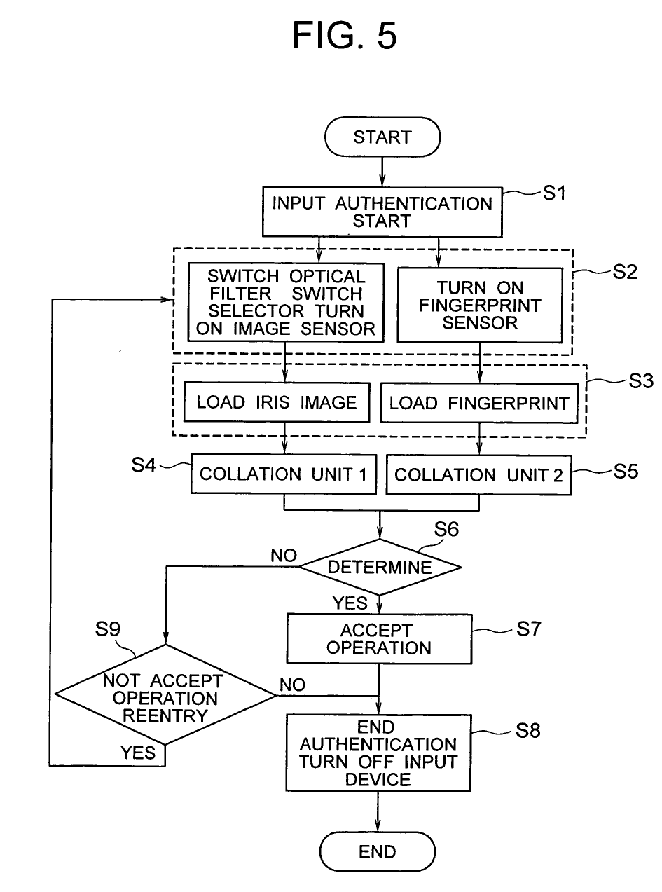

Next, authentication operation in the present embodiment will be explained by using FIGS. 4 and 5. FIG. 4 is a block diagram showing the overall configuration of the mobile phone according to the present embodiment, and FIG. 5 is a flowchart showing a series of operation of FIG. 4.

When a signal for an operation requiring preset authentication (e.g., viewing address book or financial operation) is inputted in the main controller 101 by manipulating the keyboard 11, the main controller 101 starts processing for authentication.

In step S1 in FIG. 5, the main controller 101 in FIG. 4 transmits a signal to start authentication to the authentication controller 102. When the authentication controller 102 receives the signal to start authentication, it transmits signals to start authentication to the actuator 35 and two selectors 105.

In step S2, the fingerprint sensor 20 and the image sensor 34 are turned on upon receiving the signals to start authentication from the main controller 101, so two kinds of authentication operations using images of fingerprint and iris, which are different kinds of biological information, are proceeded in parallel. Next, authentication operations using the fingerprint sensor 20 and the image sensor 34 will be explained separately.

In step S3 in FIG. 5, authentication using the fingerprint sensor 20 will be explained first. When a user holds the mobile phone 10 for using it, a finger of the user shades the fingerprint sensor 20. In this state, the user inputs a signal to start authentication into the main controller 101 by using the keyboard 11. In this case, the fingerprint of the finger of the user shading the fingerprint sensor 20 has been registered previously in the data storage 109.

When the user holding the mobile phone 10 in the state of the fingerprint sensor 20 being turned on shades the fingerprint sensor 20 with the finger previously registered on the data storage 109, the fingerprint sensor 20 captures a fingerprint image of the finger and outputs the image data to the collation unit 107.

Next, in step S5, when the collation unit 107 receives the image data from the fingerprint sensor 20, the collation unit 107 reads out registered image data of the fingerprint from the data storage 109, and collates the image data from the fingerprint sensor 20 with the image data read out from the data storage 109 so as to determine the authenticity, and outputs the determination result to the determination unit 112.

Next, authentication using the image sensor 34 will be explained. The iris information of a user of the mobile phone 10 is registered previously on the data storage 110 shown in FIG. 4. When the image sensor 34 is turned on, the optical filter switching actuator 35 receives a signal from the authentication controller 102 and disposes the infrared transmission filter 32 between the image sensor 34 and the lens 31. Further, the infrared ray irradiation circuit 103 outputs an infrared ray signal to the infrared LED 106 through the selector 105. When the infrared LED 106 receives the infrared ray signal from the infrared ray irradiation circuit 103, it outputs an infrared ray based on the signal along the optical axis direction of the image sensor 34. Based on the series of operations, preparation for capturing image data of iris for authentication using the image sensor 34 is completed.

In step S3, when the user shows the iris to the camera 30 of the mobile phone 10 in the state of preparation being completed, the image sensor 34 captures image data of the iris and outputs the iris image data to the collation unit 108 through the selector 105.

In step S5, when the collation unit 108 receives the image data outputted from the image sensor 34, it reads out the iris image data of the user (owner) previously registered in the data collation unit 110, and collates the image data from the image sensor 34 with the iris image data read out from the collation unit 110 to thereby determine the authenticity, and outputs the determination result to the determination unit 112.

In step S6, the determination unit 112 finally determines the identity based on the determination result outputted from the collation unit 107 for fingerprint image data and the determination result outputted from the collation unit 108 for iris image data, on the basis of the iris and fingerprint authentication probability.

In step S6, when the determination unit 112 accepts the user's identity (YES in step S6), the authentication controller 102 receives a signal accepting the identity from the determination unit 112, and based on the signal, transmits a signal to the main controller 101 so as to prompt it to output a signal authorizing the operation of the mobile phone 10.

In step S7, when the main controller 101 receives the signal authorizing the operation from the determination unit 112, it unlocks the security mechanism not shown. Thereby, the user can use the mobile phone 10 with input manipulation using the keyboard 11.

In step S6, if the determination unit 112 denies the user's identity (NO in step S6), the determination unit 112 outputs a signal not authorizing the operation of the mobile phone 10 to the main controller 101.

In step S6, when the main controller 101 receives the signal not authorizing the operation from the determination unit 112, it displays a message by using the display 12 to ask the person holding the mobile phone 10 whether to perform authentication with iris and fingerprint again, and waits for an input from the keyboard 11.

In step S9, if reentry is selected through the keyboard 11 (YES in step S9), the main controller 101 controls operation to the operation of step S2. On the other hand, if reentry is not selected through the keyboard 11 (NO in step S9), the process advances to the operation of step S8.

In the case of advancing to step S8, the main controller 101 outputs signals to end authentication to the optical filter actuator 35 and the two selectors 105.

When the optical filter actuator 35 receives the signal to end authentication from the main controller 101, it disposes the infrared cut filter 33 between the lens 31 and the solid-state image sensor 34 instead of the infrared transmission filter 32 disposed between the lends 31 and the solid-state image sensor 34. Thereby, the camera 30 becomes capable of capturing images with visual light.

Therefore, when the lens 31 is set toward an imaging object to be captured with visible light, image data imaged with visible light is inputted into the image processor 111, and is processed by the image processor 111. The image processor 111 outputs processed image data captured with visible light to the main controller 101. The main controller 101 processes visible light image based on an input from the keyboard 11 by the user.

(Embodiment 2)

An example of performing authentication (identification) by using images of vein and fingerprint of a user as biological information, by applying the present invention to a mobile phone which is a mobile communication terminal, will be explained as an embodiment 2.

(Description of Configuration)

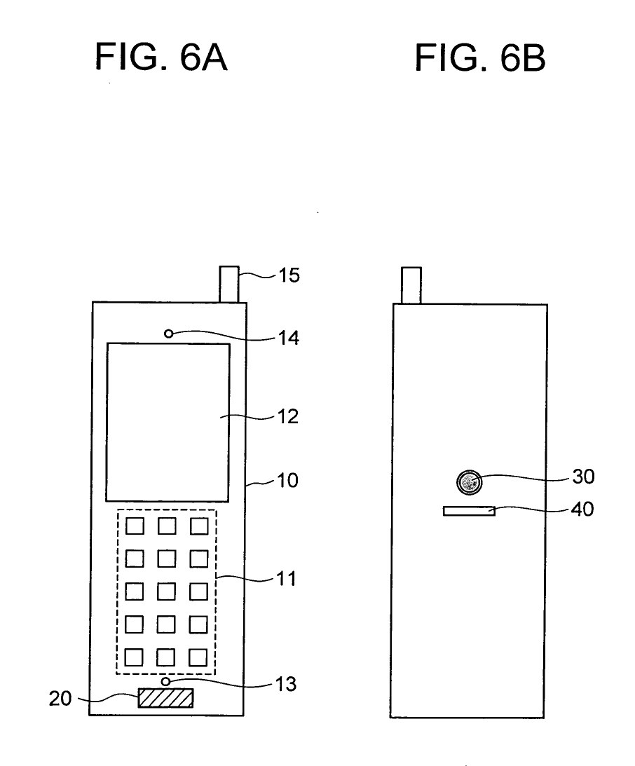

As shown in FIGS. 6A and 6B, the mobile phone 10 includes: the keyboard 11 for inputting various operations; the display 12 for displaying various information such as operational states; the microphone 13 for collecting voices; the speaker 14 for giving sounds; the antenna 15 for transmitting/receiving radio waves; the fingerprint sensor 20 for performing fingerprint authentication; the camera 30 for photographing vein images; and the infrared ray irradiation mechanism 40 for irradiating an infrared ray when an vein image is captured.

Assuming that the side of the display 12 and the keyboard 11 is the front, the camera 30 and the infrared ray irradiation mechanism 40 of the mobile phone shown in FIGS. 6A and 6B are disposed on the back face, and are arranged so as to capture objects present in the back face direction. However, FIGS. 6A and 6B are for explaining the configuration of the mobile phone of the present invention, so the positions of keyboard, display, microphone, camera, infrared ray irradiation mechanism and the like and the casing shape of the mobile phone 10 are not limited to those shown in FIGS. 6A and 6B.

The configuration of the camera 30 is same as that described by using FIGS. 2 and 3 in the embodiment 1, so the detailed description is omitted.

Further, detection of vein is so performed that infrared reflection light from the vain by irradiating an infrared ray is captured by the image sensor. Therefore, the circuit configuration of the mobile phone according to the present embodiment is same as that shown in FIG. 4 in the embodiment 1, so the detailed description is omitted.

Same as the embodiment 1, the present embodiment is also configured to enable infrared ray communications with other equipment by the infrared ray irradiation mechanism 40 shown in FIG. 6 at any time other than performing vein authentication, and the camera 30 shown in FIG. 6 is capable of capturing people and articles with visible light and being used as a camera in which images are stored as electronic data.

(Description of Operation)

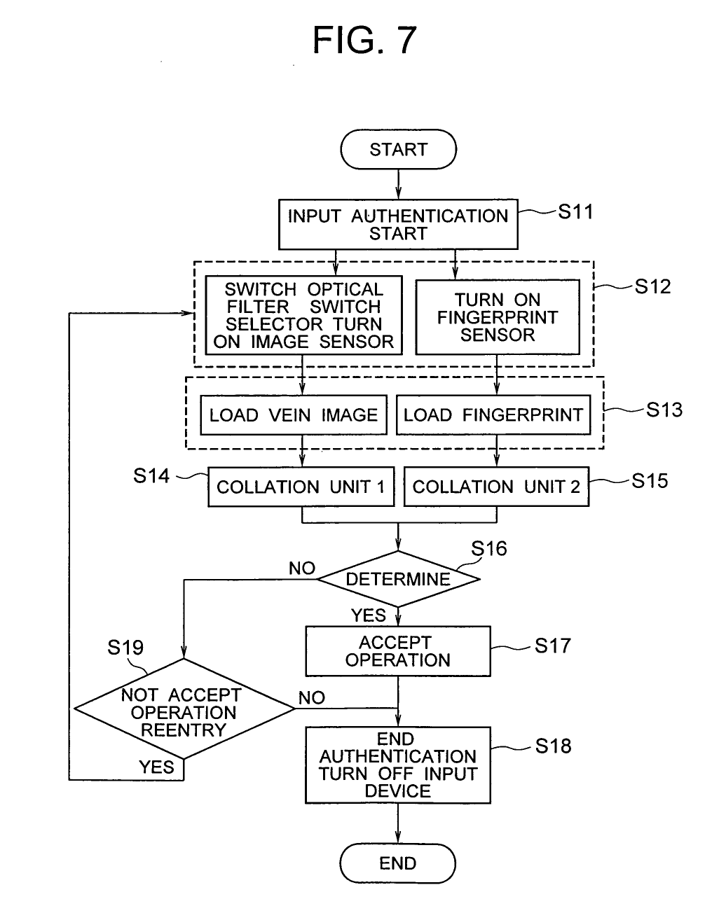

Next, authentication operation of the present embodiment will be explained by using FIGS. 4 and 7. FIG. 4 is a block diagram showing the overall configuration of the mobile phone according to the embodiment 2, and FIG. 7 is a flowchart showing a series of operation of FIG. 4.

When a user attempts to perform an operation requiring preset authentication (e.g., viewing of address book or financial operation) with an input from the keyboard 11, authentication starts.

When a signal for an operation requiring preset authentication (e.g., viewing of address book or financial operation) is inputted in the main controller 101 by manipulation of the keyboard 11, the main controller 101 starts processing for authentication.

In step S11 in FIG. 7, the main controller 101 in FIG. 4 transmits a signal to start authentication to the authentication controller 102. When the authentication controller 102 receives the signal to start authentication, it transmits signals to start authentication to the actuator 35 and two selectors 105.

In step S12, the fingerprint sensor 20 and the image sensor 34 are turned on upon receiving the signals to start authentication from the main controller 101, so two kinds of authentication operations using images of fingerprint and vein, which are different kinds of biological information, are proceeded in parallel. Next, authentication operations using the fingerprint sensor 20 and the image sensor 34 will be explained separately.

In step S13, authentication using the fingerprint sensor 20 will be explained first. When the user holding the mobile phone 10 in the state of the fingerprint sensor 20 being turned on shades the fingerprint sensor 20 with the finger previously registered on the data storage 109, the fingerprint sensor 20 captures a fingerprint image of the finger and outputs the image data to the collation unit 107.

Next, in step S15, when the collation unit 107 receives the image data from the fingerprint sensor 20, the collation unit 107 reads out registered image data of the fingerprint from the data storage 109, and collates the image data from the fingerprint sensor 20 with the image data read out from the data storage 109 so as to determine the authenticity, and outputs the determination result to the determination unit 112. In the collation unit 107, fingerprint information of the user holding the mobile phone 10 has been registered previously.

Next, authentication using the image sensor 34 will be explained. The vein information of the user of the mobile phone 10 is registered previously on the data storage 110 shown in FIG. 4. When the image sensor 34 is turned on, the optical filter switching actuator 35 receives a signal from the authentication controller 102 and disposes the infrared transmission filter 32 between the image sensor 34 and the lens 31. Further, the infrared ray irradiation circuit 103 outputs an infrared ray signal to the infrared LED 106 through the selector 105. When the infrared LED 106 receives the infrared ray signal from the infrared ray irradiation circuit 103, it outputs an infrared ray based on the signal along the optical axis direction of the image sensor 34. Based on the series of operations, preparation for capturing image data for authentication using the image sensor 34 is completed.

In step S13, when the user shows the vein to the image sensor 34 of the mobile phone 10 in the state of preparation being completed, an infrared ray is irradiated from the infrared ray irradiation mechanism 40 to the hand of the user, so the image sensor 34 captures image data of the vain of the hand on which the infrared ray is irradiated and outputs the vein image data to the collation unit 108 through the selector 105.

In step S14, when the collation unit 108 receives the image data outputted from the image sensor 34, it reads out the vein image data of the owner previously registered in the data collation unit 110, and collates the image data from the image sensor 34 with the vein image data read out from the collation unit 110 to thereby determine the authenticity, and outputs the determination result to the determination unit 112.

In step S16, the determination unit 112 finally determines the identity based on the determination result outputted from the collation unit 107 for fingerprint image data and the determination result outputted from the collation unit 108 for vein image data, on the basis of the authentication probability of vein and fingerprint.

In step S16, when the determination unit 112 accepts the user's identity (YES in step S16), the authentication controller 102 receives a signal accepting the identity from the determination unit 112, and based on the signal, transmits a signal to the main controller 101 so as to prompt it to output a signal authorizing the operation of the mobile phone 10.

In step S17, the main controller 101 outputs a signal authorizing the operation to the mobile phone 10 based on the signal accepting the identity outputted from the determination unit 112. Thereby, operation of the mobile telephone 10 is unlocked, so the user can use the mobile phone 10.

In step S16, if the determination unit 112 denies the user's identity (NO in step S6), the determination unit 112 outputs a signal not authorizing the operation of the mobile phone 10 to the main controller 101.

In step S16, when the main controller 101 receives the signal not authorizing the operation from the determination unit 112, it displays a message by using the display 12 to ask the person holding the mobile phone 10 whether to perform authentication with vein and fingerprint again, and waits for an input from the keyboard 11 (step S19).

In step S19, if reentry is selected through the keyboard 11 (YES in step S19), the main controller 101 controls operation to the operation of step S12. On the other hand, if reentry is not selected through the keyboard 11 (NO in step S19), the process advances to the operation of step S18.

In the case of advancing to step S18, the main controller 101 outputs signals to end authentication to the optical filter actuator 35 and the two selectors 105.

When the optical filter actuator 35 receives the signal to end authentication from the main controller 101, it disposes the infrared cut filter 33 between the lens 31 and the solid-state image sensor 34 instead of the infrared transmission filter 32 disposed between the lens 31 and the solid-state image sensor 34. Thereby, the camera function becomes capable of capturing images with visual light.

Therefore, when the lens 31 is set toward an imaging object to be captured with visible light, image data captured with visible light is inputted into the image processor 111, and is processed by the image processor 111. The image processor 111 outputs the processed image data captured with visible light to the main controller 101. The main controller 101 processes visible light image based on an input from the keyboard 11 by the user.

(Embodiment 3)

An example of performing authentication (identification) by using images of iris and vein of a user as biological information, by applying the present invention to a mobile phone which is a mobile communication terminal, will be explained as an embodiment 3.

(Description of Configuration)

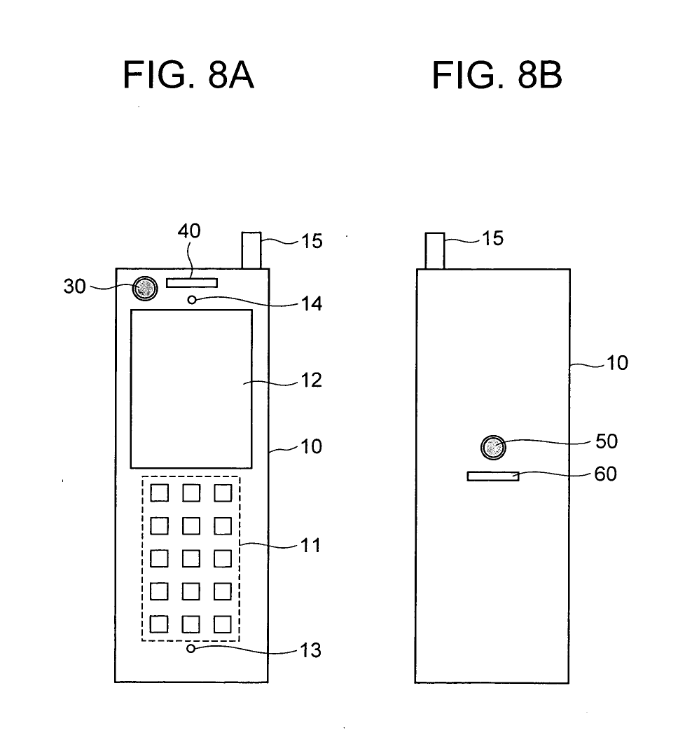

As shown in FIGS. 8A and 8B, the mobile phone 10 includes: the keyboard 11 for inputting various operations; the display 12 for displaying various information such as operational states; the microphone 13 for collecting voices; the speaker 14 for giving sounds; the antenna 15 for transmitting/receiving radio waves; the camera 30 for capturing iris images; the infrared ray irradiation mechanism 40 for irradiating an infrared ray when an iris image is captured; a camera 50 for capturing vein images; and an infrared ray irradiation mechanism 60 for irradiating an infrared ray when a vein image is captured.

Assuming that the side of the display 12 and the keyboard 11 is the front, the camera 30 and the infrared ray irradiation mechanism 40 of the mobile phone shown in FIGS. 8A and 8B are disposed on the front face, and are arranged so as to capture articles present on the front face side. Further, the camera 50 and the infrared ray irradiation mechanism 60 of the mobile phone shown in FIGS. 8A and 8B are disposed on the back face, and are arranged so as to capture articles present in the back face direction. However, FIGS. 8A and 8B are for explaining the configuration of the mobile phone of the present invention, so the positions of keyboard, display, microphone, cameras, infrared ray irradiation mechanisms and the like and the casing shape of the mobile phone 10 are not limited to those shown in FIGS. 8A and 8B.

The configuration of the cameras 30 and 50 is same as that of the camera 30 shown in FIGS. 2 and 3 in the embodiment 1, so the detailed description is omitted.

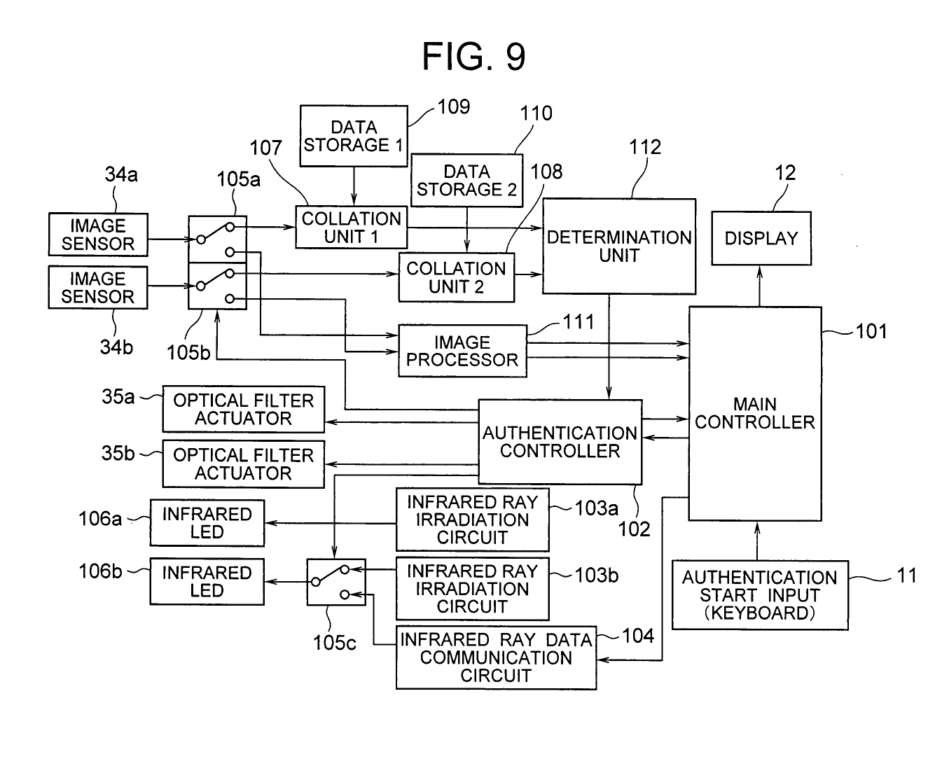

Next, the circuit configuration of the mobile phone according to the present embodiment will be shown in FIG. 9. As shown in FIG. 9, the image sensors 34a and 34b, the optical filter switching actuator 35a and 35b, the infrared LED 106a and 106b, and the infrared ray irradiation circuits 103a and 103b are provided with two pieces each in the present invention in order to capture an iris image and a vein image by irradiating infrared rays.

In the example shown in FIG. 9, the solid-state image sensor 34a, the optical filter actuator 35a, the infrared LED 106a and the infrared ray irradiation circuit 103a are used as configurations to capture iris information. The solid-state image sensor 34b, the optical filter actuator 35b, the infrared LED 106b and the infrared ray irradiation circuit 103b are used as configurations to capture vein information. Note that the solid-state image sensor 34a, the optical filter actuator 35a, the infrared LED 106a and the infrared ray irradiation circuit 103a may be used as configurations to capture vain information, and the solid-state image sensor 34b, the optical filter actuator 35b, the infrared LED 106b and the infrared ray irradiation circuit 103b may be used as configurations to capture iris information.

In the data collation unit 109, iris information of the user holding the mobile phone 10 has been registered previously. Further, in the data collation unit 110, vain information of the user holding the mobile phone 10 has been registered previously. Further, in the present embodiment, the image sensors 34a and 34b for iris image and vein image are adapted to connect with the image processor 111 at any time other than performing authentication, and both of the cameras 30 and 50 in FIGS. 8A and 8B are configured as to be usable as cameras for capturing people and articles with visible light. Further, as shown in FIG. 9, there are not so many merits in the infrared LED 106a and 106b even if infrared data communications are possible at two places, so they are configured such that one infrared LED 106a is only used for irradiating an infrared ray when performing authentication.

(Description of Operation)

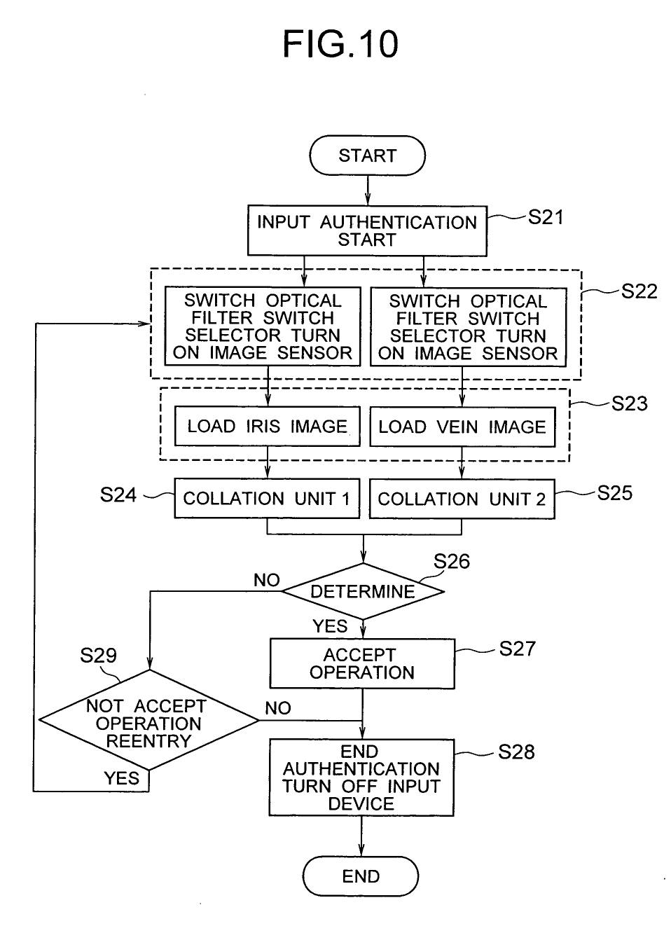

Next, authentication operation of the present embodiment will be explained by using FIGS. 9 and 10. When a signal attempting an operation required preset authentication (e.g., viewing of address book or financial operation) is inputted in the main controller 101 by manipulation of the keyboard 11, the main controller 101 starts processing for authentication.

In step S21 in FIG. 10, the main controller 101 in FIG. 9 transmits a signal to start authentication to the authentication controller 102. When the authentication controller 102 receives the signal to start authentication, it transmits signals to start authentication to the actuators 35a and 35b and the selectors 105a, 105b and 105c.

In step S22, the image sensors 34a and 34b are turned on upon receiving the signals to start authentication from the main controller 101, so two kinds of authentication operations using images of vein and iris, which are different kinds of biological information, are proceeded in parallel. Next, authentication operations using the image sensors 34a and 34b will be explained separately.

First, authentication performed by using the image sensor 34 based on iris which is biological information will be explained. The iris information of the user holding the mobile phone 10 has been registered previously on the data storage 109 shown in FIG. 9. When the image sensor 34a is turned on, the optical filter switching actuator 35a receives a signal from the authentication controller 102 and disposes the infrared transmission filter 32 between the image sensor 34a and the lens 31. Further, the infrared ray irradiation circuit 103a outputs an infrared ray signal directly to the infrared LED 106a. When the infrared LED 106a receives the infrared ray signal from the infrared ray irradiation circuit 103a, it outputs an infrared ray based on the signal along the optical axis direction of the image sensor 34a. Based on the series of operations, preparation for capturing image data of iris for authentication using the image sensor 34a is completed.

In step S23, when the user shows the iris to the camera 30 of the mobile phone 10 in the state of preparation being completed, the image sensor 34a captures image data of the iris and outputs the iris image data to the collation unit 107 through the selector 105a.

In step S24, when the collation unit 107 receives the image data outputted from the image sensor 34a, it reads out the iris image data of the user (owner) previously registered in the data collation unit 109, and collates the image data from the image sensor 34a and the iris imaging data read out from the collation unit 109 so as to determine the authenticity, and outputs the determination result to the determination unit 112.

Next, authentication performed by using the image sensor 34b based on vein which is biological information will be explained. The vein information of the user holding the mobile phone 10 has been registered previously on the data storage 110 shown in FIG. 9. When the image sensor 34b is turned on, the optical filter switching actuator 35b receives a signal from the authentication controller 102 and disposes the infrared transmission filter 32 between the image sensor 34b and the lens 31. Further, the infrared ray irradiation circuit 103b outputs an infrared ray signal to the infrared LED 106b through the selector 105c. When the infrared LED 106b receives the infrared ray signal from the infrared ray irradiation circuit 103b, it outputs an infrared ray based on the signal along the optical axis direction of the image sensor 34b. Based on the series of operations, preparation for capturing image data for authentication using the image sensor 34b is completed.

In step S23, when the user shows the vein to the camera 50 of the mobile phone 10 in the state of preparation being completed, an infrared ray is irradiated from the infrared ray irradiation mechanism 103b to the hand of the user, and the image sensor 34b captures image data of the vein of the hand on which the infrared ray is irradiated and outputs the vein image data to the collation unit 108 through the selector 105b.

In step S25, when the collation unit 108 receives the image data outputted from the image sensor 34b, it reads out the vein image data of the owner previously registered in the data collation unit 110, and collates the image data from the image sensor 34b and the vein image data read out from the collation unit 110 so as to determine the authenticity, and outputs the determination result to the determination unit 112.

In step S26, the determination unit 112 finally determines the identity based on the determination result outputted from the collation unit 107 for iris image data and the determination result outputted from the collation unit 108 for vein image data, on the basis of the authentication probability of iris and vein.

In step S26, when the determination unit 112 accepts the user's identity (YES in step S26), the authentication controller 102 receives a signal accepting the identity from the determination unit 112, and based on the signal, sends a signal to the main controller 101 so as to prompt it to output a signal authorizing the operation of the mobile phone 10.

In step S27, the main controller 101 outputs a signal authorizing the operation to the mobile phone 10 based on the signal accepting the identity outputted from the determination unit 112. Thereby, operation of the mobile telephone 10 is unlocked, so the user can use the mobile phone 10.

In step S26, if the determination unit 112 denies the user's identity (NO in step S26), the determination unit 112 outputs a signal not authorizing the operation of the mobile phone 10 to the main controller 101.

In step S26, when the main controller 101 receives the signal not authorizing the operation from the determination unit 112, it displays a message by using the display 12 to ask the person holding the mobile phone 10 whether to perform authentication with iris and vein again, and waits for an input from the keyboard 11 (step S29).

In step S29, if reentry is selected through the keyboard 11 (YES in step S29), the main controller 101 controls operation to the operation of step S12. On the other hand, if reentry is not selected through the keyboard 11 (NO in step S29), the process advances to the operation of step S28.

In the case of advancing to step S28, the main controller 101 outputs signals to end authentication to the optical filter actuators 35a and 35b and the selectors 105a, 105b and 105c.

When the optical filter actuator 35b receives the signal to end authentication from the main controller 101, it disposes the infrared cut filter 33 between the lens 31 and the solid-state image sensor 34b instead of the infrared transmission filter 32 disposed between the lens 31 and the solid-state image sensor 34b. Thereby, the camera 50 becomes capable of capturing images with visual light.

Therefore, when the lens 31 is set toward an imaging object to be captured with visible light, image data captured with visible light is inputted into the image processor 111, and is processed by the image processor 111. The image processor 111 outputs the processed visible light image data captured with visible light to the main controller 101. The main controller 101 processes the visible light image based on an input from the keyboard 11 by the user.

Among the embodiments described above, in the embodiment shown in FIG. 4, the cameras 30 and 50, the fingerprint sensor 20, the collation unit 107, the data storage 109, the image sensor 34, the collation unit 108, the data storage 110, the infrared ray irradiation mechanisms 40 and 60 and the determination unit 122 constitute authentication units for performing authentication based on fingerprint and iris which are different kinds of biological information. In the embodiment shown in FIG. 6, the fingerprint sensor 20, the collation unit 107, the data storage 109, the image sensor 34, the collation unit 108, the data storage 110, the infrared ray irradiation mechanism 40 and the determination unit 112 constitute authentication units for performing authentication based on fingerprint and vein which are different kinds of biological information. Further, in the embodiment shown in FIG. 9, the image sensor 34a, the collation unit 108, the data storage 110, the image sensor 34b, the collation unit 108, the data storage 110, the infrared ray irradiation mechanisms 40 and 60 and the determination unit 112 constitute authentication units for performing authentication based on iris and vein which are different kinds of biological information.

Further, the main controller 101 and the authentication controller 102 constitute a control unit for performing operational control of the authentication units. As described in each embodiment, the control unit has a function of proceeding with capturing of biological information and authentication processing based on the captured biological information, performed for respective kinds of biological information by the authentication units, in parallel.

As described above, the embodiments of the present invention are characterized in the configuration that capturing of biological information and authentication processing based on the captured biological information, performed for respective kinds of biological information by the authentication units, are proceeded in parallel. According to this characteristic, instead of a configuration in which a camera for capturing image data with infrared ray irradiation to be provided in the authentication unit is also used as a camera for capturing image data with visible light to be provided in the mobile communication terminal, the infrared ray irradiation mechanism for capturing authentication data by the authentication unit may also be used for data communications. In other words, in addition to a configuration with a security function using biological information for authentication, that is, a configuration in which capturing of biological information and authentication processing based on the captured biological information performed for respective kinds of biological information by the authentication units are proceeded in parallel, the mobile communication terminal according to the embodiments of the present invention may include at least an iris authentication unit for performing authentication based on biological information of iris as an authentication unit, and an infrared ray irradiation mechanism used for capturing authentication data by the iris authentication unit may also be used for data communications.

Further, the mobile communication terminal may include at least a vein authentication unit for performing authentication based on biological information of vein as the authentication unit, and an infrared ray irradiation mechanism used for capturing authentication data by the vein authentication unit may also be used for data communications. Further, the mobile communication terminal may include at least iris and vein authentication units for performing authentication based on biological information of iris and vein as the authentication units, and an infrared ray irradiation mechanism used for capturing authentication data by one of the iris and vein authentication units may also be used for data communications.

As described above, instead of a configuration in which a camera for capturing image data with infrared ray irradiation to be provided in the authentication unit is also used as a camera for capturing image data with visible light to be provided in the mobile communication terminal, it is possible to realize reduction in price and size by using an infrared ray irradiation mechanism used for capturing authentication data by the authentication unit also for data communications, compared with a case of adding an infrared ray data transmission function separately. Note that a configuration in which a camera for capturing image data with infrared ray irradiation to be provided in the authentication unit is also used as a camera for capturing image data with visible light to be provided in the mobile communication terminal and a configuration in which an infrared ray irradiation mechanism used for capturing authentication data by the authentication unit is also used for data communication may be combined.

Further, although the embodiments shown in FIGS. 4, 6 and 9 show examples in which the main controller 101, the authentication controller 102, the collation units 107 and 108, the determination unit 112 and the image processor 111 are constituted as hardware respectively, the present invention is not limited to this configuration. An authentication program for executing authentication processing in accordance with the flowchart shown in FIG. 5, 7 or 10 may be provided in a memory of a microprocessor incorporated in the mobile communication terminal, and by sequentially reading out the authentication program by the microprocessor, the operation of the circuit configuration shown in FIG. 4, 6 or 9 may be executed by means of software In such a case, the authentication program is constructed to have a configuration of prompting a microprocessor incorporated in the mobile communication terminal to execute functions of authentication units to perform authentication based on at least two kinds of biological information and a function of a control unit to proceed with capturing of biological information and authentication processing based on the captured biological information, performed for the respective kinds of biological information by the authentication units, in parallel.

Although a mobile phone is used as a mobile communication terminal in the embodiments described above, a mobile communication terminal is not limited to a mobile phone. Instead of a mobile phone, a PDA (Personal Digital Assistant), an electronic notebook, a mobile computer or the like may be used as a mobile communication terminal.

### INDUSTRIAL APPLICABILITY

As described above, according to the present invention, authentication accuracy can be improved by using two kinds of biological information. Further, by inputting two kinds of biological information at one time and performing collations in parallel, a user feels as if one authenticating operation is performed, so bothersome matters can be reduced compared with the conventional operation of performing multiple kinds of biometrics sequentially.

What is claimed is:

1. A mobile communication terminal having a security function using biological information for authentication, comprising:
authentication units for performing authentication based on at least two kinds of biological information; and
a control unit for controlling operation of the authentication units, wherein
the control unit has a function of proceeding with capturing of the biological information and authentication processing based on the biological information captured, performed for respective kinds of biological information by the authentication units, in parallel.

2. The mobile communication terminal, as claimed in claim 1, wherein the authentication units include at least an iris authentication unit for performing authentication based on biological information of iris, and
a camera of the iris authentication unit is also used as a camera for capturing image data with visible light to be provided in the mobile communication terminal.

3. The mobile communication terminal, as claimed in claim 2, wherein the camera of the iris authentication unit has a filter mechanism which transmits visible light and an infrared ray by switching between them.

4. The mobile communication terminal, as claimed in claim 3, wherein an infrared ray irradiation mechanism used for capturing authentication data by the iris authentication unit is also used for data communications.

5. The mobile communication terminal, as claimed in claim 1, wherein the authentication units include at least a vein authentication unit for performing authentication based on biological information of vein, and
a camera of the vein authentication unit is also used as a camera for capturing image data with visible light to be provided in the mobile communication terminal.

6. The mobile communication terminal, as claimed in claim 5, wherein the camera of the vein authentication unit has a filter mechanism which transmits visible light and an infrared ray by switching between them.

7. The mobile communication terminal, as claimed in claim 6, wherein an infrared ray irradiation mechanism used for capturing authentication data by the vein authentication unit is also used for data communications.

8. The mobile communication terminal, as claimed in claim 1, wherein the authentication units include an iris authentication unit and a vein authentication unit for performing authentication based on biological information of iris and vein, and
a camera of one of the iris authentication unit and the vein authentication unit is also used as a camera for capturing image data with visible light to be provided in the mobile communication terminal.

9. The mobile communication terminal, as claimed in claim 8, wherein the camera of the iris authentication unit or the vein authentication unit has a filter mechanism which transmits visible light and an infrared ray by switching between them.

10. The mobile communication terminal, as claimed in claim 9, wherein an infrared ray irradiation mechanism used for capturing authentication data by the iris authentication unit and the vein authentication unit is also used for data communications.

11. The mobile communication terminal, as claimed in claim 1, wherein the authentication units include at least an iris authentication unit for performing authentication based on biological information of iris, and
an infrared ray irradiation mechanism used for capturing authentication data by the iris authentication unit is also used for data communications.

12. The mobile communication terminal, as claimed in claim 1, wherein the authentication units include at least a vein authentication unit for performing authentication based on biological information of vein, and
an infrared ray irradiation mechanism used for capturing authentication data by the vein authentication unit is also used for data communications.

13. The mobile communication terminal, as claimed in claim 1, wherein the authentication units include at least an iris authentication unit and a vein authentication unit for performing authentication based on biological information of iris and vein, and
an infrared ray irradiation mechanism used for capturing authentication data by one of the iris authentication unit and the vein authentication unit is also used for data communications.

14. An authentication method in a mobile communication terminal comprising the steps of:
capturing data of different kinds of biological information of a user handling the mobile communication terminal; and
performing authentication based on the biological information captured in the step of capturing; wherein
capturing of the biological information and authentication processing based on the biological information captured, performed for respective kinds of biological information, are proceeded in parallel.

15. An authentication program in a mobile communication terminal for prompting a microprocessor incorporated in the mobile communication terminal to execute: functions of authentication units to perform authentication based on at least two kinds of biological information; and a function of a control unit having a function to proceed with capturing of the biological information and authentication processing based on the biological information captured, performed for respective kinds of biological information by the authentication units, in parallel.
